(19) United States
(12) Patent Application Publication
(10) Pub. No.: US 2023/0267170 A1
(43) Pub. Date: Aug. 24, 2023

(54) INFORMATION PROCESSING SYSTEM, INFORMATION PROCESSING METHOD, AND NON-TRANSITORY COMPUTER-READABLE RECORDING MEDIUM FOR INFORMATION PROCESSING PROGRAM

(71) Applicant: Hitachi, Ltd., Tokyo (JP)

(72) Inventor: Takuya OKUYAMA, Tokyo (JP)

(21) Appl. No.: 17/901,923

(22) Filed: Sep. 2, 2022

(30) Foreign Application Priority Data
Feb. 18, 2022 (JP) 2022-024260

(51) Int. Cl. G06F 17/16

(52) U.S. Cl. CPC G06F 17/16

(57) ABSTRACT

Search for an optimal solution of a constrained optimization problem that includes search for a ground state of an interaction model is sufficiently executed. An information processing system executes a first search process of performing search for an optimal solution of a first variable vector that optimizes an augmented Lagrange function in an alternating direction method of multipliers, using an optimization algorithm of an unconstrained mixed-binary quadratic programming problem, and a second search process of performing search for an optimal solution of a second variable vector that optimizes the augmented Lagrange function in the alternating direction method of multipliers, using another algorithm. The information processing system repeatedly executes the second search process performed using the optimal solution of the first variable vector determined by the first search process and the first search process performed using the optimal solution of the second variable vector determined by the second search process.

### CROSS REFERENCES TO RELATED APPLICATION

This application claims priority based on Japanese patent applications, No. 2022-024260 filed on Feb. 18, 2022, the entire contents of which are incorporated herein by reference.

### BACKGROUND

The present invention relates to an information processing system, an information processing method and a non-transitory computer-readable recording medium for an information processing program.

### Description of the Related Art

Japanese Patent Laid-Open No. 2016-51314, discloses “a semiconductor apparatus provided with a plurality of base units each of which includes a first memory cell storing values expressing one spin of an Ising model with three or more states, a second memory cell storing interaction coefficients indicating interactions with the one spin from other spins exerting interactivity with the one spin, and a logic circuit deciding a next state of the one spin based on a function having values expressing states of the other spins and the interaction coefficients as constants or variables.”

Further, International Publication No. WO 2019/216277 discloses a method for realizing optimal solution search by stochastically updating all of spins simultaneously for an Ising model having arbitrary coupling while satisfying a theoretical background required by Markov chain Monte Carlo methods.

Most of physical phenomena and social phenomena can be expressed by interaction models. An interaction model is defined by a plurality of nodes constituting the model, interactions among the nodes and, if necessary, coefficients that works on the nodes, respectively. In the fields of physics and social science, various models including an Ising model have been proposed, and all the models can be interpreted as forms of interaction model.

In solving social issues, it is important to determine a node state that minimizes or maximizes an indicator associated with the interaction model. For example, a problem of detecting a creek in a social network and a portfolio optimization problem in the financial field are given. A constraint is imposed on most of problems required to be practically solved. For example, as for the portfolio optimization problem described above, it is aimed to maximize a return of profit while investing in a plurality of financial products to reduce the risk of decrease in an appraised value. For this problem, generally, a constraint that “a sum total of invest amounts is a predetermined amount” exists.

The present invention has been made in view of the background described above, and an object is to provide a technology for efficiently executing search for an optimal solution of a constrained optimization problem that includes search for a ground state of an interaction model.

### SUMMARY

In order to solve the problem described above, one aspect of the present invention is an information processing system for performing search for an optimal solution of a constrained mixed-binary quadratic programming problem, the information processing system comprising a processing unit executing a process in cooperation with a storage unit, wherein the processing unit executes a conversion process of converting the constrained mixed-binary quadratic programming problem to an augmented Lagrange function that includes an objective function of the constrained mixed-binary quadratic programming problem, a constraint expression of the constrained mixed-binary quadratic programming problem and a penalty term based on the constraint expression, with a first variable vector and a second variable vector as variables; executes a first search process of performing search for an optimal solution of the first variable vector that optimizes the augmented Lagrange function in an alternating direction method of multipliers, using a predetermined optimization algorithm of an unconstrained mixed-binary quadratic programming problem, and a second search process of performing search for an optimal solution of the second variable vector that optimizes the augmented Lagrange function in the alternating direction method of multipliers, using another algorithm different from the predetermined optimization algorithm; and repeatedly executes the second search process performed using the optimal solution of the first variable vector determined by the first search process and the first search process performed using the optimal solution of the second variable vector determined by the second search process.

According to the present invention, it is possible to speed up search for an optimal solution of a constrained optimization problem that includes search for a ground state of an interaction model.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual diagram exemplifying a relationship between variable arrays and objective function values of an optimization problem;

FIG. 2 is a diagram exemplifying relationships among variables of an objective function of an optimization problem;

FIG. 3 is a diagram exemplifying relationships among variables of an objective function of an optimization problem;

FIG. 4 is a diagram exemplifying hardware of a computer that realizes an information processing apparatus according to an embodiment;

FIG. 5 is a functional block diagram exemplifying a configuration of the information processing apparatus according to the embodiment;

FIG. 6 is a flowchart exemplifying a whole process executed by the information processing apparatus according to the embodiment; and

FIG. 7 is a flowchart exemplifying an optimal solution search process executed by the information processing apparatus according to an embodiment.

### DESCRIPTION OF EMBODIMENT

An embodiment of the present invention will be described below with reference to drawings. The embodiment is an exemplification for describing the present invention, and omission or simplification may be appropriately performed for clarification of the description. The present invention can be carried out in other various embodiments. For each component, the number is not especially limited unless otherwise specified.

If there are a plurality of components having the same or similar functions, they may be described, being given the same reference signs with different subscripts. If it is not necessary to distinguish the plurality of components, they may be described without the subscripts.

In the embodiment, a process performed by executing a program may be described. Here, a computer executes the program by a processor (for example, a CPU (central processing unit) or a GPU (Graphics processing Unit)) and performs the process specified by the program using a storage resource (for example, a memory), interface devices (for example, a communication port) and the like. Therefore, the subject of the process performed by executing the program may be considered to be the processor. Similarly, the subject of the process performed by executing the program may be a controller, an apparatus, a system, a computer or a node that includes a processor. The subject of the process performed by executing the program may be any arithmetic unit, and a dedicated circuit for performing a particular process may be included. Here, the dedicated circuit is, for example, an FPGA (field programmable gate array), an ASIC (application specific integrated circuit), a CPLD (complex programmable logic device) or a quantum computer.

The program may be installed into the computer from a program source. The program source may be, for example, a program distribution server or a computer-readable storage medium. When the program source is a program distribution server, the program distribution server includes a processor and a storage resource for storing the distribution target program, and the processor of the program distribution server may distribute the distribution target program to other computers. In the embodiment, two or more programs may be realized as one program, and one program may be realized as two or more programs.

In the description below, for example, an expression of “A˜” is equal to an expression of “A” with “˜” directly above “A”.

### (Solution Method Utilizing Parallel Computing, for Mixed-Binary Quadratic Programming Problem)

Here, a mixed-binary quadratic programming problem is assumed as an interaction model. Variables of the optimization problem are assumed to be N variables s₁, . . . , s_{N}, and a domain Dᵢ of each variable sᵢ is assumed to be a binary value {−1,+1} or continuous values [−1,+1]. Which domain Dᵢ is to be assigned to each variable sᵢ is decided for each problem. An objective function H of the optimization problem is indicated by Formula 1. That is, the objective function H is indicated by a quadratic expression of the variable s.

[Formula 1]

H(s)=−½s^{T}Js−h^{T}s (1)

In Formula 1, s=[s₁, . . . , s_{N}] is an N-dimensional vector; J is an N×N symmetric matrix; and h is an N-dimensional vector. Since the domain differs for each variable as described before, the optimization problem is indicated by Formula 2.

$$\begin{matrix}[ Formula 2 ] & \\ {min}_{{s}_{i} ∈ {D}_{i}} H ( s ) & ( 2 )\end{matrix}$$

Here, sets of subscripts Λ_{b}and Λ_{c} are defined as shown by Formulas 3.

$$\begin{matrix}[ Formulas 3 ] & \\ \{ \begin{matrix}{Λ}_{b} = \{ i \vert {D}_{i} = \{ - 1 , 1 \} \} \\ {Λ}_{c} = \{ i \vert {D}_{i} = [ - 1 , 1 ] \}\end{matrix} & ( 3 )\end{matrix}$$

A set S_{mixed}−{s|sᵢ∈Dᵢ} is defined. By using these expressions, Formula 2 can be expressed as Formula 4.

$$\begin{matrix}[ Formula 4 ] & \\ {min}_{s ∈ {S}_{mixed}} H ( s ) & ( 4 )\end{matrix}$$

Hereinafter, for all i∈Λ_{b}, an element of the i-th row and the i-th column of the matrix J is assumed to be 0. This is because this conversion does not change an optimal solution of Formula 2.

If Dᵢ={−1,+1} is satisfied for all i, this optimization problem is a combinatorial optimization problem that is called a problem of search for a ground state of an Ising model. In the present embodiment, an optimal solution or an approximate solution is searched for by an algorithm utilizing Markov chain Monte Carlo methods (hereinafter referred to as the MCMC) in the optimization problem that includes search for a ground state of an Ising model.

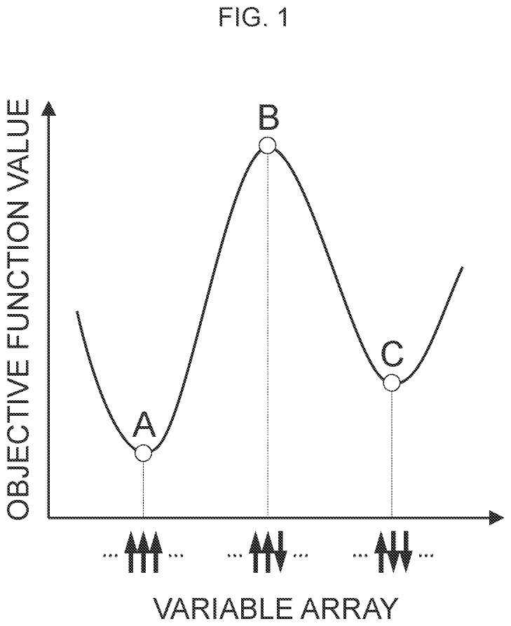

FIG. 1 is a conceptual diagram exemplifying a relationship between variable arrays and objective function values of an optimization problem and represents a landscape of the objective function values for the variable arrays. The horizontal axis of the graph indicates the variable arrays s, and the vertical axis indicates values of the objective function H. In the MCMC, stochastic transition from a current state s to a certain state s′ near the state s repeats. A probability of transition from the state s to the state s′ is referred to as a transition probability P(s, s′). As examples of methods for determining the transition probability P, a Metropolis method and a heat-bath algorithm are given.

The transition probability has a parameter called temperature, which indicates a degree of easiness of transition between states. When executing the MCMC while gradually decreasing the temperature from a large value, the objective function value converges to the lowest state (a state of minimum energy). Methods for determining an optimal solution or an approximate solution of a minimization problem utilizing the above are Simulated Annealing (hereinafter referred to as SA) and Momentum Annealing (hereinafter referred to as MA) proposed in “Binary optimization by momentum annealing,” Okuyama, T., Sonobe, T., Kawarabayashi, K. I., & Yamaoka, M., Physical Review E, 100(1), 012111 (2019).

To solve the minimization problem shown by Formula 4, consideration will be made on solving a minimization problem of Formula 5 instead. Here, a set S_{relaxed}={sᵢ∈[−1,+1]} is assumed.

$$\begin{matrix}[ Formula 5 ] & \\ {min}_{s ∈ {S}_{relaxed}} H ( s ) & ( 5 )\end{matrix}$$

An optimal solution of Formula 5 is indicated by s*=[s₁*, . . . , s_{N}*], Here, s⁺=[s₁⁺, . . . , s_{N}⁺] determined by Formula 6 is one of optimal solutions of Formula 4, though the proof thereof is omitted. That is, though an object of the present embodiment is search for an optimal solution of Formula 2, the desired solution s⁺ can also be obtained by obtaining a conversion of Formula 6 after determining an optimal solution s* of Formula 5. Here, a function sgn is a function that returns +1 if an argument is equal to or larger than 0 and otherwise returns −1.

$$\begin{matrix}[ Formula 6 ] & \\ {s}_{i}^{+} = \{ \begin{matrix}sgn ( {s}_{i}^{*} ) & ( i ∈ {Λ}_{b} ) \\ {s}_{i}^{*} & ( i ∈ {Λ}_{c} )\end{matrix} & ( 6 )\end{matrix}$$

Here, an N-dimensional vector v=[v₁, . . . , v_{N}] is introduced to define a function H′ shown by Formula 7.

[Formula 7]

H′(s, v_=H(s_+V(v) (7)

The function V(v) is as defined by Formula 8.

[Formula 8]

V(v)=½v^{T}(J+2W)v (8)

A matrix W=diag(w₁, . . . , w_{N}) is an arbitrary diagonal matrix, and vᵢ is a real number that moves within a range of [−1,+1]. Instead of the minimization problem shown by Formula 5, Formula 9, which is a minimization problem of H′(s,v) is introduced.

$$\begin{matrix}[ Formula 9 ] & \\ {min}_{s ∈ {[ - 1 , 1 ]}^{N}} H ( s ) + {min}_{υ ∈ {S [ - 1 , 1 ]}^{N}} V ( υ ) & ( 9 )\end{matrix}$$

Two N-dimensional vectors, x=s+v and y=s−v are defined. Though an objective function of the optimization problem that is originally desired to solve is only H, the function V is introduced here so that a function that can be updated in parallel by the MCMC can be newly obtained. Then, the function H′ can be rewritten as Formula 10.

$$\begin{matrix}[ Formula 10 ] & \\ {H}^{′} = \frac{1}{2} \{ - {x}^{T} Jy - {h}^{T} ( x + y ) + \frac{{( x - y )}^{T} W ( x - y )}{2} \} & ( 10 )\end{matrix}$$

That is, the minimization problem of Formula 5 can be replaced with a minimization problem of Formula 11.

$$\begin{matrix}[ Formula 11 ] & \\ {min}_{\vert {x}_{i} \vert + \vert {y}_{i} \vert \leq 2} \{ G ( x , y ) := {x}^{T} Jy - {h}^{T} ( x + y ) + \frac{{( x - y )}^{T} W ( x - y )}{2} \} & ( 11 )\end{matrix}$$

When optimal solutions of Formula 11 are indicated by x* and y*, an equation of s*=(x*+y*)/2 holds. Such a discussion holds even if W is a zero matrix.

From the above, the optimal solution of the optimization problem indicated by Formula 2 can be determined from the solutions of the quadratic constrained programming problem indicated by Formula 11. In order to determine the solutions, the MCMC is utilized.

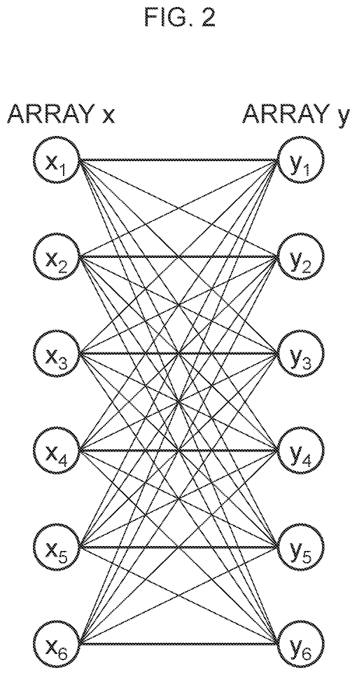

FIG. 2 is a diagram exemplifying relationships among variables of an objective function of an optimization problem, which represents a graphical model showing relationships among variables of the function G in Formula 11. Though FIG. 2 exemplifies a case of N=6, this can be similarly said for a case of general N. The relationships among the variables of the function G can be represented by a complete bipartite graph. Variables which a variable xᵢ is multiplied by within the function G are only yᵢ, . . . , y_{N} and xᵢ. When stochastically updating a variable value, the MCMC uses a value of a variable related to the variable. That is, when updating the value of the variable x₁, the MCMC determines y₁, . . . , y_{N} and x₁ but does not refer to other variables (x₂, . . . , x_{N} here). this can be similarly said for update of values of the other variables, for example, x₂. Therefore, if values of a variable array y are constant, the theoretical demand of the MCMC is not broken even if values of an array x are stochastically updated independently and simultaneously.

Similarly, variables which a variable yᵢ are multiplied by are also only x₁, . . . , x_{N} and yᵢ. Therefore, values of the array y can be stochastically updated independently and simultaneously if the values of the variable array x are constant.

From the above, by executing the MCMC configured with a procedure of repeating “simultaneous update of x₁, . . . , x_{N}” and “simultaneous update of y₁, . . . , y_{N}”, it is possible to search for the arrays x and y that minimize the function G while enjoying the advantage of speed-up due to parallelization.

It should be noted that no constraints are provided on the matrix J in the discussion of the present embodiment. Since the above discussion holds, for example, even if all the elements of the matrix J are non-zero, parallel update is possible.

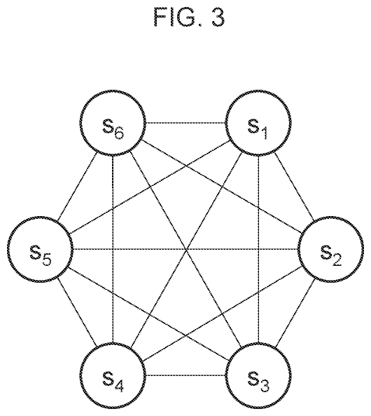

FIG. 3 is a diagram exemplifying relationships among variables of an objective function of an optimization problem, which shows an example of a complete graph (fully connected Ising model). Though FIG. 3 exemplifies a case of N=6, this can be similarly said for the case of general N. When directly applying the MCMC to the minimization problem of Formula 2, which is the original problem, stochastic update can be performed only for one variable at a time and is limited to sequential update because how the variable arrays s are related to one another is expressed by a complete graph (fully connected Ising model) as shown in FIG. 3.

From here, a procedure of stochastic update of each variable will be described. Here, an update target variable is indicated by xᵢ. If values of the variables yᵢ, . . . , y_{N} are constant, an existence probability p(xᵢ) of the variable xᵢ in a Boltzmann distribution at a temperature T satisfies Formula 12.

$$\begin{matrix}[ Formula 12 ] & \\ p ( {x}_{i} ) ∝ {e}^{- \frac{{W}_{i}}{2 T} ( {( {x}_{i} - \frac{{A}_{i}}{{W}_{i}} )}^{2} - \frac{{A}_{i}^{2}}{{W}_{i}^{2}} )} & ( 12 )\end{matrix}$$

Here, a variable Aᵢ is a value determined by Formula 13.

$$\begin{matrix}[ Formula 13 ] & \\ {A}_{i} = {h}_{i} + {w}_{i} {y}_{i} + {\sum }_{j} {J}_{ij} {y}_{j} & ( 13 )\end{matrix}$$

Since the variables xᵢ and yᵢ satisfy |xᵢ|+|yᵢ|≤2, a range in which xᵢ can be moved is a range of −(2−|yᵢ|) or more and (2-|yᵢ|) or less. Therefore, as for the variable xᵢ, the next state of xᵢ can be sampled based on a truncated normal distribution with a range of −(2−″yᵢ|) or more and (2−|yᵢ|) or less as a domain in a normal distribution with a mean Aᵢ/wᵢ and a variance T/wᵢ. In this method, a next state is decided without depending on a current state of xᵢ. This is similar for yᵢ. In the present specification, when variables of x and y are not distinguished, the variables may be expressed as s.

Random numbers according to a standard normal distribution can be generated by the Box-Muller method. Here, since a domain is limited, the algorithm can be used which is shown in “The normal law under linear restrictions: simulation and estimation via minimax tilting,” Botev, Z. I., Journal of the Royal Statistical Society: Series B (Statistical Methodology), 79(1), 125-148 (2017).

Optimal solution search can be regarded as sampling from equilibrium at a temperature of 0. Therefore, in order realize good-quality solution search, convergence to equilibrium in a short time is desirable. Various technologies are proposed in the MCMC in order to enhance convergence to equilibrium, and utilization thereof is possible. For example, an over-relaxation method is proposed by “Suppressing random walks in Markov chain Monte Carlo using ordered overrelaxation” Neal, R. M., in Learning in Graphical Models (pp. 205-228), Springer, Dordrecht, (1998). As candidates for the next state, not one state but K states are sampled from the Boltzmann distribution at the temperature T. Then, a total of (K+1) states including a current state in addition to the sampled K states are rearranged and represented as x_{c}⁰≤ . . . ≤x_{c}^{r}−xᵢ≤x_{c}^{K}. That is, the current state is the (r+1)th value from the smallest value among the (K+1) values. Then, x_{c}^{K+1-r} is adopted as a next state. In this method, a next state depends on a current state of xᵢ.

### (Solution Method for Constrained Mixed-Binary Quadratic Programming Problem Using Alternating Direction Method of Multipliers)

A solution method to an unconstrained mixed-binary quadratic programming problem (the MCMC) has been described so far. Hereinafter, a solution method to a constrained mixed-binary quadratic programming problem targeted by the present application will be described. Formula 14 below will be considered as the constrained mixed-binary quadratic programming problem.

$$\begin{matrix}[ Formula 14 ] & \\ {min}_{x ∈ 𝒳} H ( x ) subject to ξ ( x ) \leq 0 & ( 14 )\end{matrix}$$

A set X:={{xᵢ}ᵢ₌₁, . . . , n|xᵢ∈Dᵢ} and a set Dᵢ are closed sections. This formulation includes a QUBO (quadratic unconstrained binary optimization) problem and a mixed-binary QP (quadratic programming) problem. An indicator function Is for a set S is defined as below.

$$\begin{matrix}[ Formula 15 ] & \\ {I}_{S} ( x ) := \{ \begin{matrix}0 & ( x ∈ S ) \\ ∞ & ( otherwise )\end{matrix} & ( 15 )\end{matrix}$$

A set Y:={y∈Rⁿ|ξ(y)≤0} is assumed to be a convex set. Since ξ(y) may be a linear function of y, Y is not necessarily a closed set.

By using Formula 15, Formula 14 can be represented as below.

$$\begin{matrix}[ Formula 16 ] & \\ {min}_{x ∈ {ℝ}^{n} , y ∈ {ℝ}^{n}} \{ H ( x ) + {I}_{𝒳} ( x ) + {I}_{𝒴} ( y ) \} subject to x - y = 0 & ( 16 )\end{matrix}$$

The following augmented Lagrange function is defined.

$$\begin{matrix}[ Formula 17 ] & \\ {ℒ}_{ρ} ( x , y , λ ) := H ( x ) + {I}_{𝒳} ( x ) + {I}_{𝒴} ( y ) + {λ}^{⊤} ( x - y ) + \frac{ρ}{2} {‖ x - y ‖}^{2} & ( 17 )\end{matrix}$$

When a vector v=λ/ρ is introduced, Formula 17 can be rewritten as Formula 18.

$$\begin{matrix}[ Formula 18 ] & \\ {ℒ}_{υ} ( x , y , υ ) = H ( x ) + {I}_{𝒳} ( x ) + {I}_{𝒴} ( y ) + \frac{ρ}{2} {‖ x - y + υ ‖}^{2} - \frac{ρ}{2} {‖ υ ‖}^{2} & ( 18 )\end{matrix}$$

It is known that, by repeating the optimization calculation below according to an alternating direction method of multipliers, each of x and y converges to certain one point as shown by Formulas 19 if ρ is sufficiently large.

$$\begin{matrix}[ Formula 19 ] & \\ x ← {arg min}_{x ∈ {ℝ}^{n}} {ℒ}_{υ} ( x , y , υ ) & ( 19 )\end{matrix}$$

$$y ← {arg min}_{y ∈ {ℝ}^{n}} {ℒ}_{υ} ( x , y , υ )$$

$$υ ← υ + x - y$$

A specific calculation method of Formulas 19 will be shown below. The first formula of Formulas 19 can be transformed as Formula 20. That is, it comes down to an unconstrained mixed-binary quadratic programming problem in the case of fixing y and moving x, with the coefficient matrix of the second term of Formula 1 as J˜:=J−ρI, and the coefficient vector of the first term as h˜:=h+ρ(y−v). Here, I is a unit matrix. As stated before, this optimization problem can be efficiently solved by the MCMC described above.

$$\begin{matrix}[ Formula 20 ] & \\ \begin{matrix}{arg min}_{x ∈ {ℝ}^{n}} {ℒ}_{υ} ( x , y , υ ) = {arg min}_{x ∈ {ℝ}^{n}} [ H ( x ) + {I}_{𝒳} ( x ) + \frac{ρ}{2} {‖ x - y + υ ‖}^{2} ] \\ = {arg min}_{x ∈ 𝒳} [ H ( x ) + \frac{ρ}{2} {‖ x - y + υ ‖}^{2} ] \\ = {arg min}_{x ∈ 𝒳} [ H ( x ) + \frac{ρ}{2} {x}^{⊤} x - {ρ ( y - υ )}^{⊤} x ] \\ = {arg min}_{x ∈ 𝒳} [ - \frac{1}{2} {x}^{⊤} \tilde{J} x - {\tilde{h}}^{⊤} x ]\end{matrix} & ( 20 )\end{matrix}$$

The second formula of Formulas 19 can be represented as Formula 21 by using a vector c=x+v. However, x here is x that determined from the first formula of Formulas 19 immediately before. That is, the formula comes down to a constrained mixed-binary quadratic programming problem in the case of fixing x and moving y.

$$\begin{matrix}[ Formula 21 ] & \\ \begin{matrix}{arg min}_{y ∈ {ℝ}^{n}} {ℒ}_{υ} ( x , y , υ ) = {arg min}_{y ∈ 𝒴} [ {‖ x - y ‖}^{2} + 2 {υ}^{⊤} ( x - y ) ] \\ = {arg min}_{y \vert ξ ( y ) \leq 0} {‖ x - y + υ ‖}^{2} \\ = {arg min}_{y \vert ξ ( y ) \leq 0} {‖ y - c ‖}^{2}\end{matrix} & ( 21 )\end{matrix}$$

The third formula of Formulas 19 is a calculation formula for updating the vector v using x and y determined from the first and second formulas of Formulas 19 immediately before and the vector v before the update.

Functions ξ₁(y), . . . , ξₘ(y) are assumed to be convex. A function ξ(y)=maxᵢ₋₁, . . . ₘξᵢ(y) is convex. For these, ξ₁(y)≤0, . . . , ξₘ(y)≤0⇔ξ(y)≤0 is satisfied. A constraint expressed by a convex function will be considered below. When a convex function of ξₘ(y)=aᵢ^{T}x−uᵢ having a finite real number uᵢ is considered, ξ(y)≤0⇔aᵢ^{T}x≤uᵢ is satisfied. Further, when a convex function of ξᵢ(y)=lᵢ−aᵢ^{T}x having a finite real number lᵢ is considered, ξ(y)≤0⇔lᵢ≤aᵢ^{T}x is satisfied.

Therefore, for a convex function of ξᵢ(y)=(aᵢ^{T}x−lᵢ) (aᵢ^{T}x−uᵢ) having the finite real numbers lᵢ and uᵢ, ξ(y)≤0⇔lᵢ≤aᵢ^{T}x≤uᵢ is satisfied. Therefore, a constraint of L≤Ax≤U can be treated as ξ(y)≤0. This constraint includes an equality constraint and is an important inequality constraint that appears in many real problems.

An optimization problem of Formula 22 below in which ξ(y)≤0 of Formula 21 is replaced with L≤Ax≤U.

$$\begin{matrix}[ Formula 22 ] & \\ {min}_{x ∈ {ℝ}^{n}} {‖ x - c ‖}^{2} subject to L \leq Ax \leq U & ( 22 )\end{matrix}$$

This linear inequality constrained minimum-norm problem can be solved by the Hildreth's algorithm shown in “A quadratic programming procedure,” C. Hildreth, Naval Research Logistics Quarterly, vol. 4, no. 1, pp. 79-85, (1957).

There has been proposed so far means for solving a linear inequality constrained mixed-binary quadratic programming problem by alternately executing an optimization method such as an annealing method for efficiently solving an unconstrained mixed-binary quadratic programming problem and the Hildreth's algorithm, which is a continuous optimization algorithm that has conventionally existed.

### (Rounding to Feasible Solution Using Gradient Information)

By an alternating direction method of multipliers, it is possible to efficiently solve a problem to be solved, using an appropriate optimization method for each of components of the problem. However, the alternating direction method of multipliers ensures convergence to feasible solutions only under particular conditions, and, in general conditions, feasible solutions have not been necessarily reached at the end of the alternating direction method of multipliers. This is inappropriate for practical use. Therefore, a method for efficient rounding to feasible solutions using gradient information in a mixed-binary quadratic programming problem will be presented.

As heuristics for determining feasible solutions of an integer programming problem, a feasibility pump method is known (“The feasibility pump,” Matteo Fischetti, Fred Glover & Andrea Lodi, Mathematical Programming, volume 104, pages 91-104 (2005)). Here, a method for applying the feasibility pump method to the rounding to feasible solutions of a mixed-binary quadratic programming problem described above will be shown.

First, a general idea of the feasibility pump method will be introduced. It is assumed to have a vector x˜ as solution candidates of an integer programming problem represented by Formula 23.

$$\begin{matrix}[ Formula 23 ] & \\ {min}_{x ∈ {ℤ}^{n}} {c}^{⊤} x subject to L \leq Ax \leq U & ( 23 )\end{matrix}$$

In the feasibility pump method, as one of positions to be searched after the vector x˜, a shortest distance vector is determined within a range of observing a constraint. The vector is obtained by solving Formula 24. Since it is a linear programming problem that does not include an integer constraint, an exact solution can be easily determined by a simplex method or the like. Here, Δ(x˜,x) indicates distance between the vectors x˜ and x, and, generally, an L1 norm is used.

$$\begin{matrix}[ Formula 24 ] & \\ {min}_{x ∈ {ℝ}^{n}} Δ ( \tilde{x} , x ) subject to L \leq Ax \leq U & ( 24 )\end{matrix}$$

In Formula 24 above, the objective function of Formula 23 is not considered. As a method for determining a feasible solution with a smaller objective function value, a method exists in which a solution of a linear programming problem of Formula 25 is set as a position to be searched after the vector x˜. A constant α is a parameter that decides a degree of importance of an improvement range of the objective function value relative to a distance from a current position.

$$\begin{matrix}[ Formula 25 ] & \\ {min}_{x ∈ {ℝ}^{n}} \{ ( 1 - α ) Δ ( \tilde{x} , x ) + α {c}^{T} x \} subject to L \leq Ax \leq U & ( 25 )\end{matrix}$$

The conventional feasibility pump method has been described so far. When the idea thereof is quoted for the feasible solution search of the mixed-binary quadratic programming problem (Formula 1), the linear programming problem of Formula 25 can be solved on the assumption of c:=−J˜x−h. This gradient vector is a mere matrix product and can be calculated by a GPU or the like at a high speed. In this way, in the alternating direction method, optimal solutions x^{m} and y^{m} (m is a natural number) by the m-th optimization process, which are used to search for optimal solutions x^{m+1} and y^{m+1} by the (m+1)th optimization process using Formulas 19, can be rounded to feasible optimal solution candidates.

### (Hardware Configuration of Information Processing Apparatus 10)

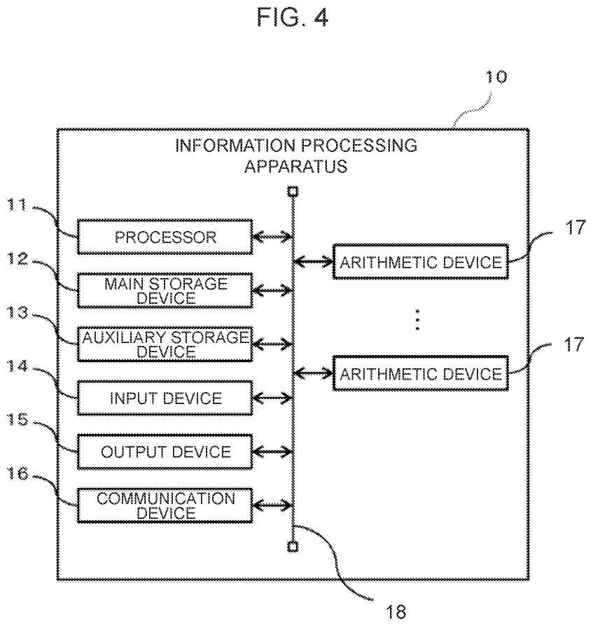

FIG. 4 is a diagram exemplifying hardware of a computer that realizes an information processing apparatus 10 according to the embodiment. The information processing apparatus 10 has a processor 11, a main storage device 12, an auxiliary storage device 13, an input device 14, an output device 15, a communication device 16, one or more arithmetic devices 17 and a system bus 18 that communicably connects these devices. A part or the whole of the information processing apparatus 10 may be realized, for example, using a virtual information processing resource like a cloud server provided by a cloud system. Further, the information processing apparatus 10 may be realized, for example, by a plurality of communicably connected information processing apparatuses operating in cooperation with one another.

The processor 11 is configured, for example, with a CPU (central processing unit) or an MPU (micro-processing unit). The main storage device 12 is a device that stores programs and data. For example, the main storage device 12 is a ROM (read-only memory), an SRAM (static random access memory), an NVRAM (non-volatile RAM), a mask ROM (mask read-only memory), a PROM (programmable ROM), a RAM (random access memory), a DRAM (dynamic random access memory) or the like. The auxiliary storage device 13 is an HDD (hard disk drive), a flash memory, an SSD (solid state drive), an optical storage device (a CD (compact disc), a DVD (digital versatile disc) or the like), or the like. A program and data stored in a non-transitory computer readable recording medium such as the auxiliary storage device 13 are read to the main storage device 12 as needed.

The input device 14 is a user interface that accepts input of information from a user, and is, for example, a keyboard, a mouse, a card reader, a touch panel or the like. The output device 15 is a user interface that provides information for the user and is, for example, a display device that visualizes various kinds of information (an LCD (liquid crystal display), a graphic card or the like), a voice output device (speaker), a printing device or the like. The communication device 16 is a communication interface that communicates with other apparatuses and is, for example, an NIC (network interface card), a wireless communication module, a USB (universal serial interface) module, a serial communication module or the like.

The arithmetic device 17 is a device that executes a process related to search of an optimal solution of a combinatorial optimization problem. The processor 17 may be, for example, in a form of an expansion card attached to the information processing apparatus 10, like a GPU (graphical processing unit). The arithmetic device 17 is configured, for example, with hardware such as a CMOS (complementary metal oxide semiconductor) circuit, an FPGA or an ASIC.

The arithmetic device 17 includes a control device, a storage device, an interface for connecting to the system bus 18 and the like and performs transmission/reception of commands and information to/from the processor 11 via the system bus 18. The arithmetic device 17 may be, for example, communicably connected to other arithmetic devices 17 to operate in cooperation with the other arithmetic devices 17. A function realized by the arithmetic device 17 may be realized, for example, by causing a processor (a CPU, a GPU or the like) to execute a program.

In the information processing apparatus 10, by a program being read from the auxiliary storage device 13 and executed by cooperation between the processor 11 and the main storage device 12, functions of the information processing apparatus 10 is realized. Or alternatively, the program for realizing the functions of the information processing apparatus 10 may be acquired from an external computer by communication via the communication device 16. Or alternatively, the program for realizing the functions of the information processing apparatus 10 may be recorded in a portable recording medium (an optical disc, a magnetic disk, a magneto-optical disc, a semiconductor storage medium or the like) and read by a medium reading device.

Further, the information processing apparatus 10 may be an information processing apparatus including a plurality of devices that execute a process in cooperation with each other. Programs that realize the information processing system realize functions similar to the functions of the information processing apparatus 10 by causing the apparatuses to realize the functions, respectively, by each program.

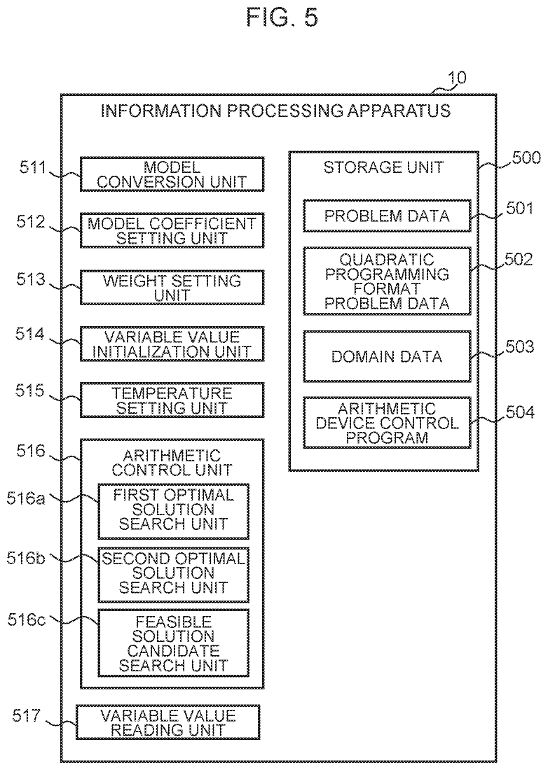

FIG. 5 shows main functions (software components) that the information processing apparatus 10 is provided with. As shown in FIG. 5, the information processing apparatus 10 is provided with a storage unit 500, a model conversion unit 511, a model coefficient setting unit 512, a weight setting unit 513, a variable value initialization unit 514, a temperature setting unit 515, an arithmetic control unit 516 and a variable value reading unit 517. Further, the arithmetic control unit 516 includes a first optimal solution search unit 516a, a second optimal solution search unit 516b and a feasible optimal solution candidate search unit 516c. These functions are realized by the processor 11 reading and executing the program stored in the main storage device 12 or by hardware the arithmetic device 17 is provided with. In addition to the above functions, the information processing apparatus 10 may be provided with other functions such as an operating system, a file system, device drivers, a DBMS (database management system) and the like.

Among the above functions, the storage unit 500 stores problem data 501, quadratic programming format problem data 502, domain data 503 and an arithmetic device control program 504 in the main storage device 12 or the auxiliary storage device 13. The problem data 501 is, for example, data described in a publicly known predetermined description format. The problem data 501 is, for example, set by the user via a user interface (an input device, an output device, a communication device or the like).

The quadratic programming format problem data 502 is data generated by the model conversion unit 511 converting the problem data 501 to data in a format corresponding to the format of the constrained mixed-binary quadratic programming problem shown by Formula 14. At the time of the conversion, a given domain of each variable is written to the domain data 503. The domain data 503 shows, for example, whether each variable takes a binary value or a real value. The arithmetic device control program 504 is a program that the arithmetic control unit 516 executes at the time of controlling the arithmetic device 17 or that the arithmetic control unit 516 loads to each individual arithmetic device 17 to cause the arithmetic device 17 to execute the program.

The model conversion unit 511 converts the problem data 501 to the quadratic programming format problem data 502 in a format which is a format of a quadratic constrained programming problem. Therefore, a function of deriving Formula 16 from Formula 14 can be implemented in the model conversion unit 511 as software or hardware in advance. The function of the model conversion unit 511 is not necessarily required to be implemented in the information processing apparatus 10. The information processing apparatus 10 may capture the quadratic programming format problem data 502 generated by another information processing apparatus or the like via the input device 14 or the communication device 16.

The model coefficient setting unit 512 sets the coefficient matrix J of Formula 1 based on the quadratic programming format problem data 502 in a non-linear coefficient memory, and the coefficient vector h in a linear coefficient memory. The weight setting unit 513 decides a value of a weight as described later.

The variable value initialization unit 514 initializes a value of each variable stored in a variable memory of the arithmetic device 17. The variable value initialization unit 514 can, for example, uniformly decide the value of each variable by random sampling from a range of −1 or more and +1 or less. At this time, attention should be paid to satisfy constraints about the variable. As one of the constraints, |xᵢ|+|yᵢ|≤2 is given. Other constraints are conceivable.

The temperature setting unit 515 sets temperatures T used when the arithmetic control unit 516 performs optimal solution search.

For each temperature T set by the temperature setting unit 515, the arithmetic control unit 516 causes the arithmetic device 17 to execute operation of searching for the variable arrays x and y that minimize the objective function represented by Formula 16 (hereinafter referred to as interaction operation by an alternating direction method of multipliers). At the time of the interaction operation by the alternating direction method of multipliers, the arithmetic control unit 516 causes the temperature T to change from the highest toward the lowest.

In order to execute the interaction operation by the alternating direction method of multipliers, the arithmetic control unit 516 introduces a Lagrange multiplier (a vector λ or vector v) to define the augmented Lagrange function of Formula 17 or 18. Then, the first optimal solution search unit 516a of the arithmetic control unit 516 derives the optimization problem of Formula 20 from the first formula of Formulas 19, and solves the optimization problem to obtain an optimal solution x. The first optimal solution search unit 516a is a predetermined arithmetic device that executes annealing.

The second optimal solution search unit 516b of the arithmetic control unit 516 derives the optimization problem of Formula 22 from the second formula of Formulas 19 via Formula 21, and obtains an optimal solution y using an algorithm such as the Hildreth's algorithm shown in “A quadratic programming procedure,” C. Hildreth, Naval Research Logistics Quarterly, vol. 4, no. 1, pp. 79-85, (1957). The second optimal solution search unit 516b is another type of arithmetic device different from the predetermined arithmetic device described above, which executes a liner solver and the like.

Then, the feasible optimal solution candidate search unit 516c of the arithmetic control unit 516 obtains feasible optimal solution candidates x and y to be searched for next time, by solving such an optimization problem as shown by Formula 24 or 25, based on the optimal solutions x and y (rounding to feasible solutions). The feasible optimal solution candidate search unit 516c is an arithmetic device that executes a local solution search algorithm and the like.

Then, the arithmetic control unit 516 updates the Lagrange multiplier (the vector X or the vector v) based on the vector v used in the optimal solution search this time and the feasible optimal solution candidates x and y obtained by rounding to feasible solutions, like the third formula of Formulas 19. Then, the arithmetic control unit 516 executes search for a solution of the optimization problem of Formula 20 by the first optimal solution search unit 516a, search for a solution of the optimization problem of Formula 22 by the second optimal solution search unit 516b and rounding of the searched solutions to feasible solutions until an end condition is satisfied.

When the optimization search by the arithmetic control unit 516 ends, the variable value reading unit 517 reads the variable arrays x and y stored in the variable memory. The values read here are solutions of Formula 16. According to the above discussion, an N-dimensional vector s*=(x+y)/2 is calculated. Then, the domain data 503 is read, and the vector s⁺ obtained by Formula 6 is outputted to the output device 15 or the communication device 16 as a final solution. That is, if the i-th domain in the domain data 503 proves to be {−1,+1}, sgn(s*ᵢ) is outputted. If the i-th domain is [−1,+1], sᵢ itself is outputted. In this way, a solution according to a domain is determined.

### (Flow of Whole Process)

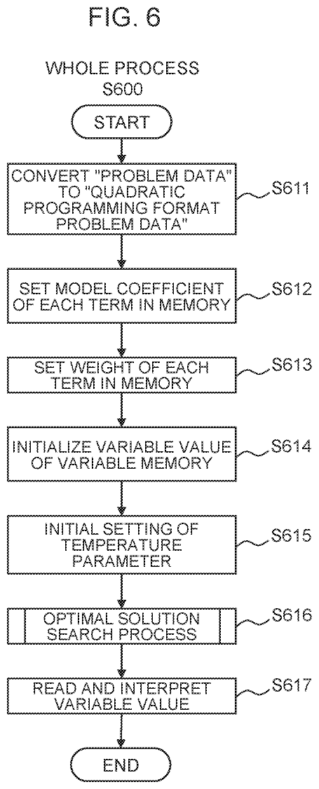

FIG. 6 is a flowchart describing a process performed by the information processing apparatus 10 at the time of optimal solution search (hereinafter referred to as a whole process S600). The whole process S600 will be described below with reference to FIG. 6. In the description below, the character “S” attached before each reference sign means a process step. The whole process S600 is started, for example, by accepting an instruction or the like from the user via the input device 14.

As shown in FIG. 6, the model conversion unit 511 converts the problem data 501 to the quadratic programming format problem data 502 first (S611). In the quadratic programming format problem data 502, for example, the matrix J and the vector h of the function H expressed by Formula 14 are expressed in arbitrary formats. If the storage unit 500 already stores the quadratic programming format problem data 502, the process S611 is omitted. The process of S611 and processes of and after S612 may be executed by different apparatuses, respectively. Further, the process of S611 and the processes of and after S612 may be executed at different timings. (For example, it is conceivable to perform the process of S611 in advance.)

Then, the model coefficient setting unit 512 sets values of the matrix J and the vector h in the memory (S612). It is also possible for the user to set or edit the values of the memory via a user interface (for example, it is realized by an input device 14, an output device 15, a communication device 16, or the like).

Then, the weight setting unit 513 decides a value of a weight. As described in the above description of Formula 8, it is allowed to take an arbitrary value in search for an optimal solution. Therefore, the value may be always set to 0. In this case, the calculation load can be reduced. Further, eigenvalues of the matrix J may be decided first as shown in Formulas 3 to 5 of International Publication No. WO 2019/216277. Or alternatively, row sums of the matrix J may be decided first. Calculation of the values may be executed within the arithmetic device 17 or by the processor 11. Or alternatively, the user may set the values himself (S613).

Then, the variable value initialization unit 514 initializes values of variables stored in the memory (S614). The values stored in the memory are continuous values. As described earlier, the initial values may be random. Now, parameters expressing Formula 16 have been set.

Then, the temperature setting unit 515 sets a temperature parameter sequence Tₖ (k=1, 2, 3, . . . ) used in optimal solution search (S615). The above subscript k indicates the type of the set temperature T. As for a method for setting the temperature T, for example, the method of Japanese Patent Laid-Open No. 2016-51314 can be adopted.

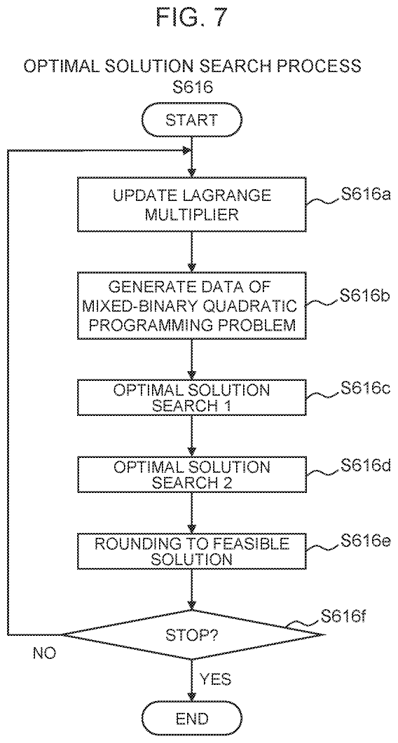

Then, the arithmetic control unit 516 executes an optimal solution search process (S616). Details of S616 will be described later with reference to FIG. 7.

At S617, the variable value reading unit 517 reads the values of the variables stored in the variable memory and the domains of the variables of the quadratic programming format problem data 502 stored in the domain data 503. Then, a vector is calculated through conversion based on Formula 6 and outputted as a solution of Formula 2 or 4. Then, the whole process S600 ends.

### (Flow of Optimal Solution Search Process)

Specific calculation of S616 of FIG. 6 will be described in detail with reference to FIG. 7.

First, the arithmetic control unit 516 updates the Lagrange multiplier (the vector λ or the vector v) of the augmented Lagrange function of Formula 17 or 18 (S616a).

Next, the arithmetic control unit 516 generates data of the optimization problems shown by Formulas 20 and 21 (S616b). Then, the first optimal solution search unit 516a solves the optimization problem shown by Formula 20 generated at S616b by an optimization technique such as the annealing method (S616c).

Next, the second optimal solution search unit 516b solves the optimization problem shown by Formula 21 by the Hildreth's algorithm or the like (S616d).

Next, the feasible optimal solution candidate search unit 516c quotes the idea of the feasibility pump method to round the optimal solutions obtained at S616c and S616d to feasible optimal solution candidates (S616e).

Next, the arithmetic control unit 516 confirms whether the end condition is satisfied or not (S616f). If a condition determined in advance, such as the number of repetitions of the optimal solution search process S616 having reached a predetermined number of times or feasible solutions having already been reached, is satisfied, the arithmetic control unit 516 ends the optimal solution search process S616. On the other hand, if the end condition determined in advance is not satisfied, the arithmetic control unit 516 returns the process to S616a, updates the Lagrange multiplier (the vector X or the vector v) based on the feasible optimal solution candidates obtained by the most recent execution of S616e, and executes S616b to S616e.

As described above in detail, according to the information processing apparatus 10 of the present embodiment, it is possible to efficiently perform search for an optimal solution of a constrained mixed-binary quadratic programming problem. Therefore, it is possible to efficiently solve an optimization problem. The information processing apparatus 10 (including the arithmetic device 17) can be inexpensively and easily manufactured because of its simple configuration.

### (Other Embodiments)

An arithmetic circuit may be configured with software or with hardware as far as the arithmetic circuit is provided with the function of executing calculation for solving an optimization problem already described. Specifically, not only hardware that is implemented with an electronic circuit (a digital circuit or the like) by the annealing method but also hardware implemented with a superconducting circuit is also possible. Further, hardware that realizes an Ising model by a method other than the annealing method is also possible. For example, a laser network method (optical parametric oscillation) and a quantum neural network are known. Further, though some ideas are different, a quantum gate method in which calculation performed by an Ising model is replaced with a gate such as a Hadamard gate, a rotating gate or a Control-Not gate can also be adopted as a configuration of the present embodiment.

As one implementation example of the arithmetic circuit, the arithmetic circuit can be implemented as a CMOS (complementary metal-oxide semiconductor) integrated circuit or a logic circuit on an FPGA. For example, as disclosed in Japanese Patent Laid-Open No. 2016-51314, it is also possible to arrange many units to which the SRAM (static random access memory) technology is applied and arrange a memory for storing variables and a circuit for updating the variables in each unit.

Although the present disclosure has been described with reference to example embodiments, those skilled in the art will recognize that various changes and modifications may be made in form and detail without departing from the spirit and scope of the claimed subject matter. For example, the above embodiment has been described in detail to explain the present invention in an easy-to-understand manner and is not limited to such that is provided with all the described components. Further, it is also possible to replace a part of components of a certain embodiment with components of other embodiments or add, to components of a certain embodiment, a component of another embodiment. Further, for a part of components of each embodiment, it is possible to add, delete, replace, integrate or distribute the components. Further, the components and processes shown in the embodiment can be appropriately distributed, integrated or exchanged based on processing efficiency or implementation efficiency.

What is claimed is:

1. An information processing system for performing search for an optimal solution of a constrained mixed-binary quadratic programming problem, the information processing system comprising a processing unit executing a process in cooperation with a storage unit, wherein
the processing unit executes a conversion process of converting the constrained mixed-binary quadratic programming problem to an augmented Lagrange function that includes an objective function of the constrained mixed-binary quadratic programming problem, a constraint expression of the constrained mixed-binary quadratic programming problem and a penalty term based on the constraint expression, with a first variable vector and a second variable vector as variables;
executes a first search process of performing search for an optimal solution of the first variable vector that optimizes the augmented Lagrange function in an alternating direction method of multipliers, using a predetermined optimization algorithm of an unconstrained mixed-binary quadratic programming problem, and a second search process of performing search for an optimal solution of the second variable vector that optimizes the augmented Lagrange function in the alternating direction method of multipliers, using another algorithm different from the predetermined optimization algorithm; and
repeatedly executes the second search process performed using the optimal solution of the first variable vector determined by the first search process and the first search process performed using the optimal solution of the second variable vector determined by the second search process.

2. The information processing system according to claim 1, wherein
the predetermined optimization algorithm is an algorithm including:
a conversion process of converting the unconstrained mixed-binary quadratic programming problem to a quadratic programming problem indicated by an objective function that includes a product of a first state variable vector, a predetermined matrix and a second state variable vector; and
a state update process of performing stochastic update of the first state variable vector and the second state variable vector by repeating a process of calculating a first vector by multiplying the predetermined matrix and the first state variable vector, performing stochastic update of the second state variable vector based on a stochastic distribution that includes a parameter based on the first vector, calculating a second vector by multiplying the predetermined matrix and the second state variable vector and performing stochastic update of the first state variable vector based on a stochastic distribution that includes a parameter based on the second vector; and
the other algorithm is a continuous optimization algorithm.

3. The information processing system according to claim 1, wherein
the processing unit searches for feasible optimal solution candidates of the constrained mixed-binary quadratic programming problem based on the optimal solution of the first variable vector and the optimal solution of the second variable vector, using a local solution search algorithm; and
newly searches for an optimal solution of the first variable vector and an optimal solution of the second variable vector using the feasible optimal solution candidates, in the first search process and the second search process.

4. The information processing system according to claim 3, wherein
the processing unit searches for such feasible optimal solution candidates of the first variable vector and feasible optimal solution candidates of the second variable vector that a distance between the optimal solution of the first variable vector and the optimal solution of the second variable vector is the shortest, within a range of observing the constraint expression.

5. The information processing system according to claim 3, wherein
the processing unit searches for such feasible optimal solution candidates of the first variable vector and feasible optimal solution candidates of the second variable vector that a weighted sum of a distance between the optimal solution of the first variable vector and the optimal solution of the second variable vector and the objective function of the constrained mixed-binary quadratic programming problem is minimized, within a range of observing the constraint expression.

6. The information processing system according to claim 3, wherein
the processing unit updates a Lagrange multiplier of the augmented Lagrange function based on the optimal solution of the first variable vector and the optimal solution of the second variable vector; and
executes the first search process and the second search process for the augmented Lagrange function to which the updated Lagrange multiplier is applied, to newly search for an optimal solution of the first variable vector and an optimal solution of the second variable vector.

7. The information processing system according to claim 6, wherein
the processing unit repeatedly executes the first search process and the second search process while updating the Lagrange multiplier and the feasible optimal solution candidates until a predetermined end condition is satisfied.

8. An information processing method executed by an information processing system, the information processing system being for performing search for an optimal solution of a constrained mixed-binary quadratic programming problem, wherein
in cooperation with a storage unit, an information processing unit of the information processing system
executes a conversion process of converting the constrained mixed-binary quadratic programming problem to an augmented Lagrange function that includes an objective function of the constrained mixed-binary quadratic programming problem, a constraint expression of the constrained mixed-binary quadratic programming problem and a penalty term based on the constraint expression, with a first variable vector and a second variable vector as variables;
executes a first search process of performing search for an optimal solution of the first variable vector that optimizes the augmented Lagrange function in an alternating direction method of multipliers, using a predetermined optimization algorithm of an unconstrained mixed-binary quadratic programming problem, and a second search process of performing search for an optimal solution of the second variable vector that optimizes the augmented Lagrange function in the alternating direction method of multipliers, using another algorithm different from the predetermined optimization algorithm; and
repeatedly executes the second search process performed using the optimal solution of the first variable vector determined by the first search process and the first search process performed using the optimal solution of the second variable vector determined by the second search process.

9. A non-transitory computer-readable recording medium for storing a program for causing a computer to execute a process for performing search for an optimal solution of a constrained mixed-binary quadratic programming problem, the process comprising:
converting the constrained mixed-binary quadratic programming problem to an augmented Lagrange function that includes an objective function of the constrained mixed-binary quadratic programming problem, a constraint expression of the constrained mixed-binary quadratic programming problem and a penalty term based on the constraint expression, with a first variable vector and a second variable vector as variables;
first searching for an optimal solution of the first variable vector that optimizes the augmented Lagrange function in an alternating direction method of multipliers, using a predetermined optimization algorithm of an unconstrained mixed-binary quadratic programming problem; and
second searching for an optimal solution of the second variable vector that optimizes the augmented Lagrange function in the alternating direction method of multipliers, using another algorithm different from the predetermined optimization algorithm;
wherein the second searching using the optimal solution of the first variable vector determined by the first searching and the first searching using the optimal solution of the second variable vector determined by the second searching are repeatedly executed.

10. The non-transitory computer-readable recording medium according to claim 9, wherein
the predetermined optimization algorithm is an algorithm including:
a conversion process of converting the unconstrained mixed-binary quadratic programming problem to a quadratic programming problem indicated by an objective function that includes a product of a first state variable vector, a predetermined matrix and a second state variable vector; and
a state update process of performing stochastic update of the first state variable vector and the second state variable vector by repeating a process of calculating a first vector by multiplying the predetermined matrix and the first state variable vector, performing stochastic update of the second state variable vector based on a stochastic distribution that includes a parameter based on the first vector, calculating a second vector by multiplying the predetermined matrix and the second state variable vector and performing stochastic update of the first state variable vector based on a stochastic distribution that includes a parameter based on the second vector; and
the other algorithm is a continuous optimization algorithm.

11. The non-transitory computer-readable recording medium according to claim 9, wherein
feasible optimal solution candidates of the constrained mixed-binary quadratic programming problem based on the optimal solution of the first variable vector and the optimal solution of the second variable vector are searched for using a local solution search algorithm, and
a new optimal solution of the first variable vector and a new optimal solution of the second variable vector are searched for using the feasible optimal solution candidates in the first searching and the second searching.

12. The non-transitory computer-readable recording medium according to claim 11, wherein
such feasible optimal solution candidates of the first variable vector and feasible optimal solution candidates of the second variable vector are searched for that a distance between the optimal solution of the first variable vector and the optimal solution of the second variable vector is the shortest within a range of observing the constraint expression.

13. The non-transitory computer-readable recording medium according to claim 11, wherein
such feasible optimal solution candidates of the first variable vector and feasible optimal solution candidates of the second variable vector are searched for that a weighted sum of a distance between the optimal solution of the first variable vector and the optimal solution of the second variable vector and the objective function of the constrained mixed-binary quadratic programming problem is minimized within a range of observing the constraint expression.

14. The non-transitory computer-readable recording medium according to claim 11, wherein
a Lagrange multiplier of the augmented Lagrange function is updated based on the optimal solution of the first variable vector and the optimal solution of the second variable vector, and
a new optimal solution of the first variable vector and a new optimal solution of the second variable vector are searched for in the first searching and the second searching for the augmented Lagrange function to which the updated Lagrange multiplier is applied.

15. The non-transitory computer-readable recording medium according to claim 14, wherein
the first searching and the second searching are repeated while updating the Lagrange multiplier and the feasible optimal solution candidates until a predetermined end condition is satisfied.
